(19) United States
(12) Patent Application Publication
(10) Pub. No.: US 2015/0343834 A1
(43) Pub. Date: Dec. 3, 2015

(54) SYSTEM AND METHOD FOR PRESERVING BOOKS AS AN ASTHETIC WORK

(71) Applicant: Joaquin Burgos, New York, NY (US)

(72) Inventor: Joaquin Burgos, New York, NY (US)

(21) Appl. No.: 14/291,491

(22) Filed: May 30, 2014

(51) Int. Cl. B44B 1/00

(52) U.S. Cl. CPC B44B 1/00

(57) ABSTRACT

A method for preserving books and creating an aesthetic work of art includes a step of cutting a first arc in a book and removing a first cut piece from the book to reveal a portion of a page beneath. A second arc is cut in the book, the second arc being concentric with the first arc and having a smaller radius than the first arc, and a second cut piece is removed from the book to reveal a portion of another, subsequent page beneath the cut page. A third arc is cut in the book, the third arc being concentric with the first and second arcs and having a smaller radius than the first and second arcs, and a third cut piece is removed from the book to reveal a portion of a further subsequent page. The book is then covered with a transparent or semi-transparent shell. In an embodiment, a laser cutter is used to cut the arcs. The method may also be practiced using patterns of concentric rectangles instead of arcs.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of artistic works, and in particular to a novel method for preserving books as works of art.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a perspective view of a laser cutter cutting an arc in the cover of a book.

FIG. 2 shows perspective view illustrating a cut portion of a cover being removed.

FIG. 3 shows a perspective view illustrating a book having a concentric arc pattern cut therein.

FIG. 4 shows a top view illustrating a book that has been cut into multiple pieces.

FIG. 5 shows a perspective view illustrating a second concentric arc pattern cut in a piece of the cut book of FIG. 4.

FIG. 6 shows a top view illustrating book pieces having a transparent shell.

FIGS. 7A and 7B show front and rear views, respectively, of a book that has been covered by a transparent shell.

FIG. 7C shows a side view illustrating a book with a shell having cutouts therein.

FIG. 8 shows an example of a finished work in accordance with one embodiment of the disclosed method.

### DETAILED DESCRIPTION

Reference is made below in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Taught below is a method for preserving one or more books as a work of art. In an embodiment, the method includes the steps of using a laser to cut concentric arcs into a book, thereby exposing portions of multiple pages of the book. The arcs may be circles or semicircles, or a combination thereof. The arcs may be ovals or semiovals, or a combination thereof. One or more books so cut are then each encased in a shell, which may be a transparent or semitransparent acrylic shell. In an embodiment, instead of a pattern of concentric arcs, a pattern of concentric rectangles or portions of rectangles having at least three sides can be cut. The rectangles may be squares.

The book selected for preservation as an art work preferably has sequential pages that show images using different colors. Examples of such books include art books published by publishing houses Taschen and Phaidon. Such books typically have many images within their pages and have colorful hardback covers. The pages in such books are particularly suitable because they are glossy, relatively hard and thick, comprising paper that is between 130 and 200 grams in weight.

In an embodiment, planning steps are first used to determine how many concentric arcs will be cut in a book and where on the book such arcs will be cut. The book is first measured and inspected. At least the length and width of the book are measured, but the depth may also be measured. In this respect, the exact size, location and number of arcs can be planned. Once measured, the book or a portion of it can be replicated in vector graphics editing software and the arcs can be drawn on the reproduced book using the software. An example of vector graphics editing software that can be used in the planning steps is the Coreldraw graphics suite developed and marketed by Corel Corporation of Ottawa, Canada.

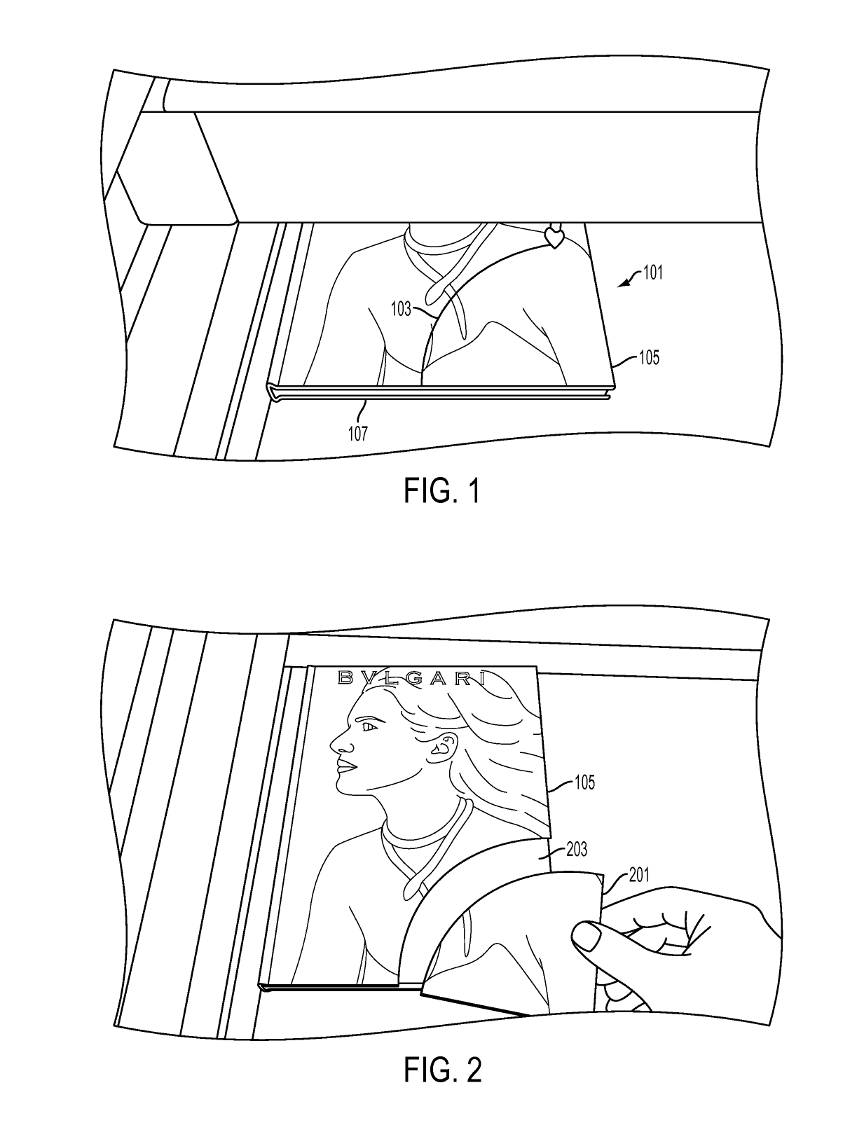

With reference to FIG. 1, in an embodiment, a laser engraving and cutting system 101 is then used to cut an arc 103 through the cover 105 of the book 107. Such laser engraving and cutting systems are used in the architectural industry to cut cardboard in connection with making small scale models of buildings. An example of a laser engraving and cutting system that can be used in the presently disclosed process is the VersaLASER VL-200 laser engraving and cutting system available from Universal Laser Systems, Inc. of Scottsdale, Ariz. The laser cutter is first cleaned, and then the book is placed on the cutter according to the plan. Care should be taken to place the book the correct distance from the laser so that it is not burned during the cutting process.

As shown in FIG. 2, once the first arc is cut, a portion 201 of the cover 105 that has been cut off is removed, exposing a portion 203 the first page of the book.

Subsequent concentric arcs of sequentially smaller radii are then sequentially cut from pages within the book and the underlying page portions that have been cut away are sequentially removed to reveal portions of pages beneath. This is done by reducing the diameter of the arc with each arc that is cut so as to create a pattern of sequentially cut concentric arcs is created. In an embodiment, the diameter is reduced in 5 mm increments. In other embodiments, the diameter is reduced in 10 mm increments and 2.5 mm increments.

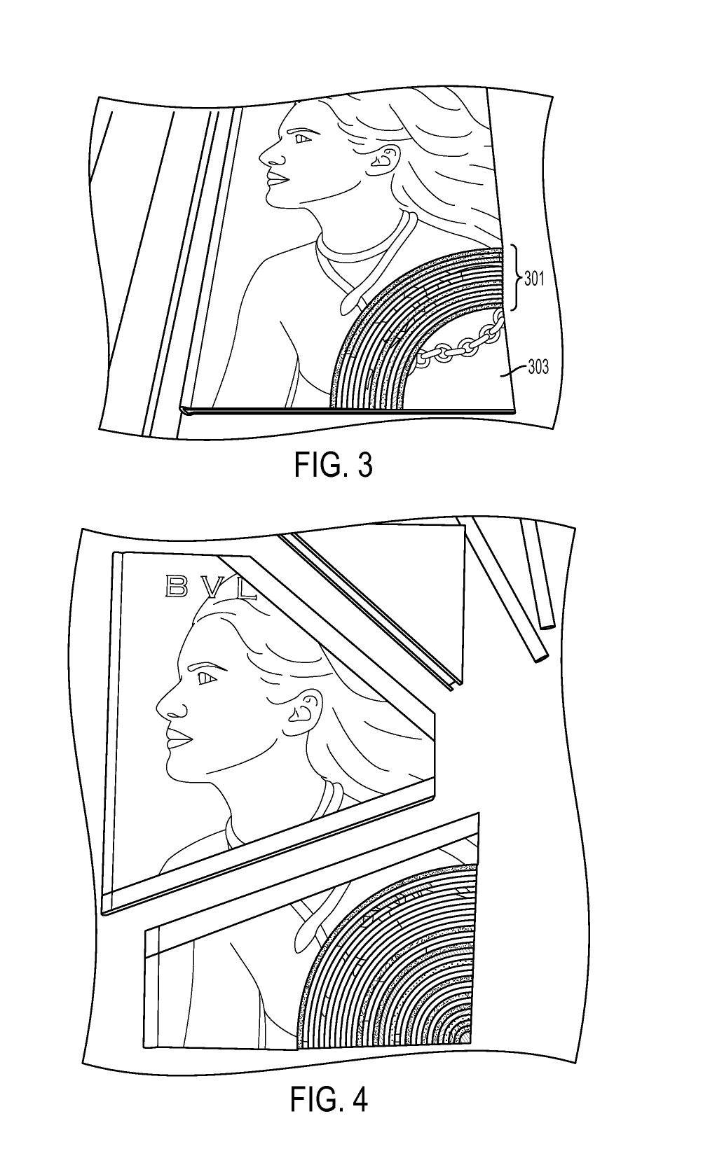

The result is shown in FIG. 3. In this case, the cover and thirteen pages have been cut and the cut pieces have been removed. This leaves small arc-shaped portions of the first through thirteen pages 301 exposed and a larger portion of the fourteenth page 303 exposed.

From here, the page cutting process can be stopped or the process may continue with arcs of sequentially smaller radii being cut in pages fourteen onward. In an embodiment, the reducing, cutting, and removing process continues until the corner 113 is reached. In an embodiment, the reducing, cutting, and removing process continues until an arc has been cut that has the smallest radius possible with the laser cutter, e.g. 5 mm for the VL-200 cutter. In an embodiment, the reducing, cutting, and removing process continues until an arc having a diameter of 10 mm has been cut. Further, separate sets of concentric arcs may then be cut in the book if desired.

With reference to FIG. 4, the book may then optionally be cut into multiple pieces. In an embodiment, if the art work being produced includes a single book, the book is cut into multiple pieces to add interest to the work. If, on the other hand, the art work being produced includes multiple books, the books may remain as single pieces and affixed together to form the work. In this regard, a rectangular or U-shaped slot may be cut in a first book so that a second book may be inserted into the first book, as shown in FIG. 8. Tape can be used, as shown, to mark the placement of the cut, and white glue may be used to bind pages together if any of the cuts will create a piece without a binding.

With continuing reference to FIG. 4, in this embodiment a single book will be used to form the art work and two cuts are made in the book so that it is in three parts. These parts will be affixed together into a single work in subsequent steps.

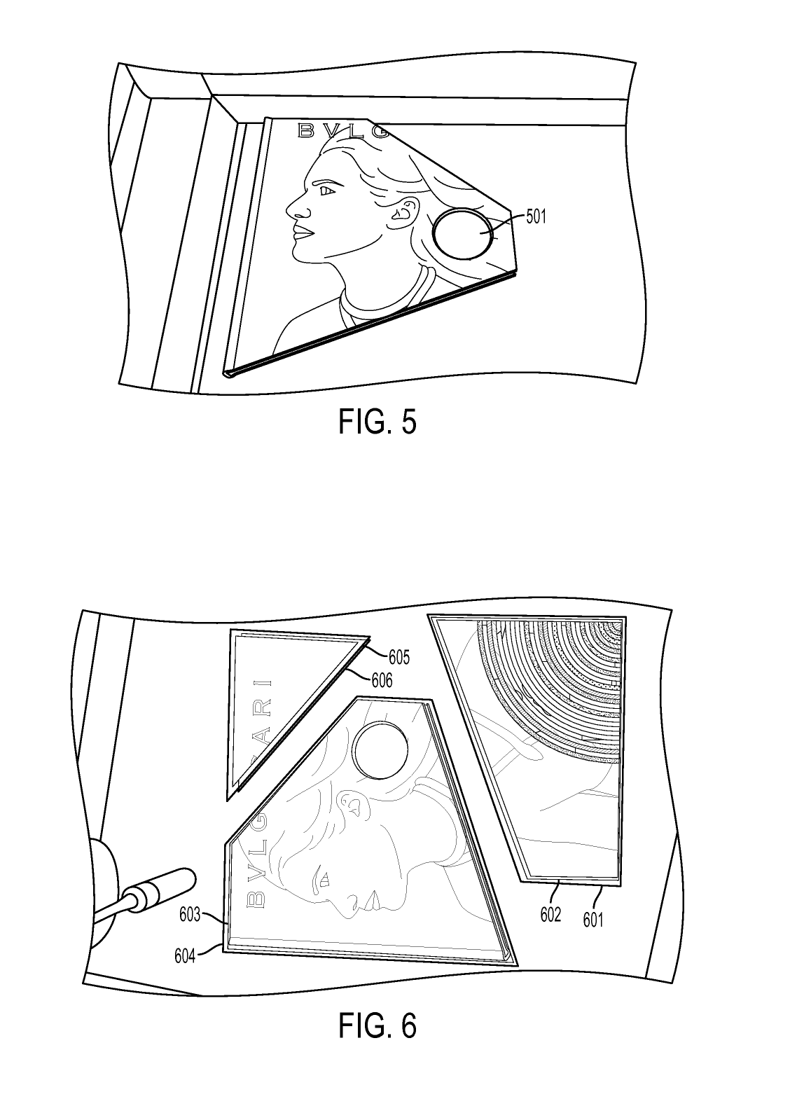

With reference to FIG. 5, in an embodiment, a further set of concentric arcs may be cut in a part of the book using the method described above to create another pattern 501. The method described herein is not limited to having just two sets of concentric arcs. A book can have as many sets of concentric arcs as necessary to look aesthetic.

Next, the book or pieces thereof are covered with a transparent or semi-transparent shell. The shell may comprise, e.g., an acrylic material such as Lucite or a polycarbonate material such as Lexan. Other plastic material can be used for the shell. Glass may be used for the shell, but it is more easily broken and is difficult to cut using a machine. The transparent or semi-transparent shell material may be colored or uncolored. The shell may comprise rigid transparent material (such as acrylic) that is cut to form a cover, a counter cover, and connecting pieces to unite them. The cover, counter cover and connecting pieces can be attached together or to the book so as to form an acrylic box that encases the book. The shell may further comprise a non-transparent material such as cement, wood, Corian, plastic, acrylic, glass, aluminum or marble, particularly at the edges. The transparent or semi-transparent shell material may comprise a transparent or semi-transparent coating that hardens.

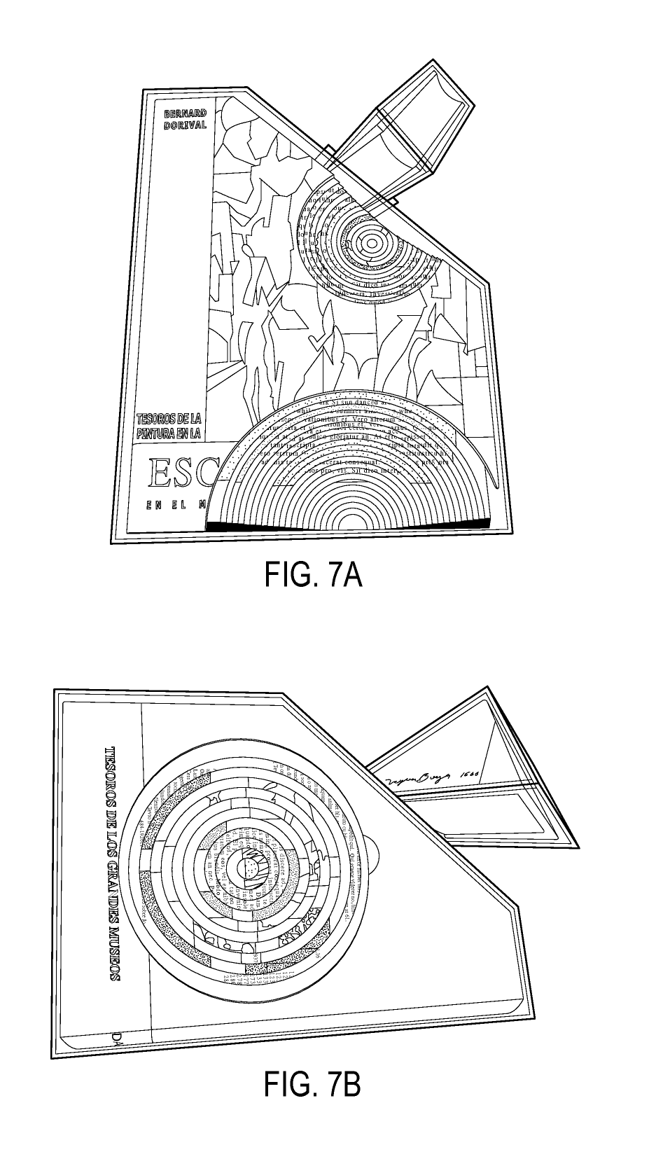

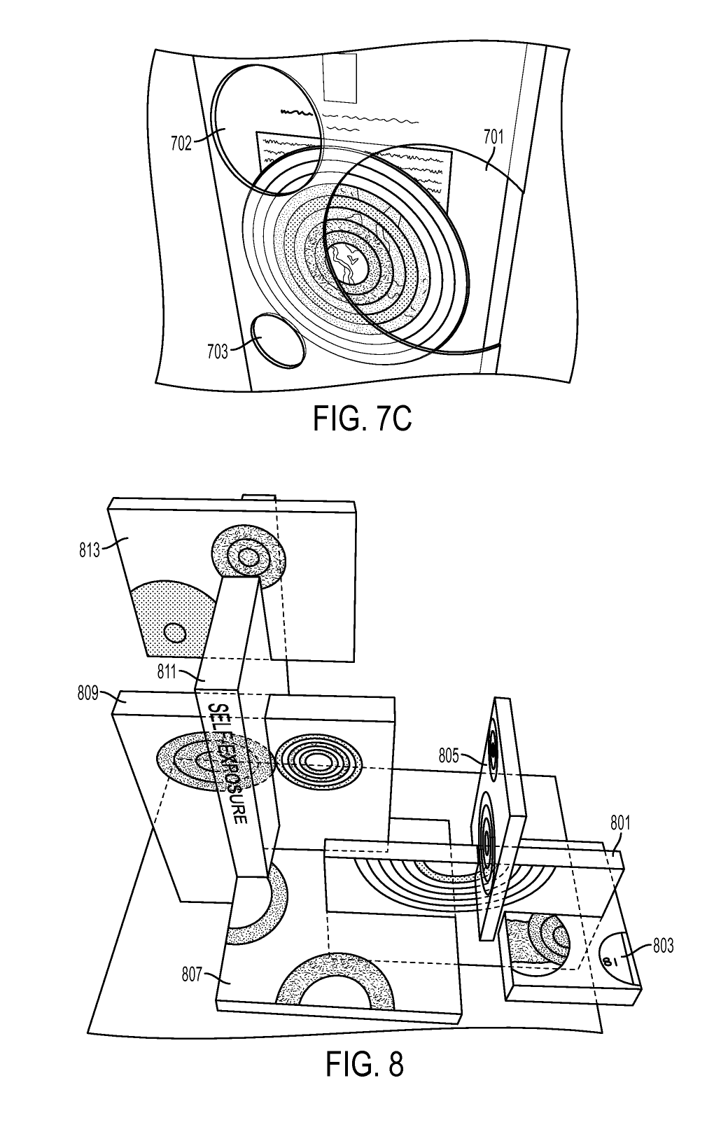

In the embodiment shown in FIG. 6, a rigid material transparent or semi-transparent material has been used to form the shell. In this case, a transparent acrylic material has been cut into six pieces 601-606 that generally match the shapes and sizes of the respective pieces of the book, and the pieces 601-606 of the shell have been affixed to the front and back surfaces of each of the pieces of the book. The sides of the book may be covered with a shell in much the same manner. The pieces of transparent or semi-transparent shell are then adhered together with adhesive or acrylic cement, or adhered to the book, so that all exposed surfaces are covered and the book is thus protected. In an embodiment, the pieces of shell are sealed so as to create an airtight seal around the book. FIGS. 7A and 7B show a front view and a rear view, respectively, of a book that has been sealed on all surfaces.

With reference to FIG. 7C, cutouts 701, 702, 703 may be made in the shell. The cutouts may be circular or semicircular to match the general shape of the concentric arc patterns or patterns in the book beneath the shell. The cutouts may be made at locations on the shell that match up with the concentric arc patterns, or may be offset from the patterns as shown.

Multiple books or portions of a single book can be interleaved to form a single work. In this respect, a rectangular or U-shaped notch or slot can be cut in one book or portion of a book and a second book or portion of a book can be inserted into such notch. FIG. 8 shows an example of a finished work in accordance with an embodiment of the disclosed process. In this example, book 801 is inserted into a notch in book 803; book 805 is inserted into a notch in book 801; book 801 is inserted into a notch in book 807; book 807 is inserted into a notch in book 809; book 809 is inserted into a notch in book 811; and book 811 is inserted into a notch in book 813. Alternatively, the method may include a step of inserting a whole book into another book and then cutting the arcs on both books. In another embodiment, the method includes not cutting a notch but laser cutting one or more sets of arcs on two separate books, putting both books together and then applying the shell.

As used herein, “book” means a piece that has multiple pages, and includes, e.g., a hardcover book, a softcover book, a magazine, a pamphlet, or the like.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A method for preserving one or more books and creating an aesthetic work of art, comprising:
cutting a first arc in a book;
removing a first cut piece from the book to reveal a portion of a page;
cutting a second arc in the book, the second arc being concentric with the first arc and having a smaller radius than the first arc;
removing a second cut piece from the book to reveal a portion of a subsequent page;
cutting a third arc in the book, the third arc being concentric with the first and second arcs and having a smaller radius than the first and second arcs;
removing a third cut piece from the book to review a portion of a further subsequent page; and,
covering the book with a transparent or semi-transparent shell.

2. The method for creating an aesthetic work of art according to claim 1, wherein at least one of the steps of cutting the first arc, cutting a second arc and cutting a third arc comprises using a laser cutter.

3. The method for creating an aesthetic work of art according to claim 1, wherein the shell comprises an acrylic material.

4. The method for creating an aesthetic work of art according to claim 3, wherein the acrylic material is transparent.

5. The method for creating an aesthetic work of art according to claim 4, wherein the acrylic material is colored.

6. The method for creating an aesthetic work of art according to claim 1, wherein the shell has multiple colors.

7. The method for creating an aesthetic work of art according to claim 1, wherein the shell comprises a plastic material.

8. The method for creating an aesthetic work of art according to claim 1, wherein the shell comprises glass.

9. The method for creating an aesthetic work of art according to claim 1, wherein the shell further comprises a non-transparent material.

10. The method for creating an aesthetic work of art according to claim 9, wherein the non-transparent material is a material selected from the set consisting of cement, wood, Corian, plastic, acrylic, glass, aluminum or marble.

11. The method for creating an aesthetic work of art according to claim 1, further comprising a step of cutting the book into multiple pieces and fastening the pieces together to form a single work.

12. The method for creating an aesthetic work of art according to claim 1, further comprising cutting a notch in the book and inserting a second book into the notch, thereby creating a single work.

13. The method for creating an aesthetic work of art according to claim 1, further comprising a planning step wherein a length and width of the book are measured and the book is reproduced in software using vector graphics editing software .

14. The method for creating an aesthetic work of art according to claim 1, wherein the arc is a full circle.

15. The method for creating an aesthetic work of art according to claim 1, wherein the arc is a semicircle.

16. The method for creating an aesthetic work of art according to claim 1, further comprising:
cutting the transparent or semitransparent material to form a cover, a counter cover, and connecting pieces; and,
attaching the cover, counter cover and connecting pieces to each other or to the a portion of the book so as to form an acrylic box that encases the book.

17. The method for creating an aesthetic work of art according to claim 1, wherein the book is a hard cover book.

18. The method for creating an aesthetic work of art according to claim 1, wherein the book has hard pages.

19. The method for creating an aesthetic work of art according to claim 1, wherein the book is a magazine.

20. The method for creating an aesthetic work of art according to claim 1, wherein the book is a pamphlet.

21. The method for creating an aesthetic work of art according to claim 1, wherein more than three arcs are cut.

22. The method for creating an aesthetic work of art according to claim 1, further comprising continuing to laser cut further arcs until an arc has been cut which has a radius that is as small as possible with the laser cutter being used.

23. The method for creating an aesthetic work of art according to claim 1, wherein a top surface of the book is covered by the shell.

24. The method for creating an aesthetic work of art according to claim 1, wherein six sides of the book are covered by the shell.

25. The method for creating an aesthetic work of art according to claim 24, wherein the shell is sealed.

26. The method for creating an aesthetic work of art according to claim 1, further comprising inserting the whole book into another book and then cutting arcs on both books.

27. The method for creating an aesthetic work of art according to claim 1, further comprising cutting one or more sets of arcs on a second book and joining the book and the second book together.

28. The method for creating an aesthetic work of art according to claim 27, wherein the step of covering the book with the transparent or semi-transparent shell comprises covering the book and the second book with the transparent or semi-transparent shell.

29. The method for creating an aesthetic work of art according to claim 1, wherein the first, second and third arcs are ovals or portions of ovals.

30. The method for creating an aesthetic work of art according to claim 1, wherein the book comprises two or more sheets of paper.

31. The method for creating an aesthetic work of art according to claim 1, wherein the book comprises two or more sheets of cardboard.

32. The method for creating an aesthetic work of art according to claim 1, wherein the book comprises two or more sheets of cellulose material.

33. A method for preserving one or more books and creating an aesthetic work of art, comprising:
cutting a first rectangular pattern in a book;
removing a first cut piece from the book to reveal a portion of a page;
cutting a second rectangular pattern in the book, the second rectangular pattern being concentric with the first rectangular pattern and having a smaller radius than the first rectangular pattern;
removing a second cut piece from the book to reveal a portion of a subsequent page;
cutting a third rectangular pattern in the book, the third rectangular pattern being concentric with the first and second rectangular pattern and having a smaller radius than the first and second rectangular patterns;
removing a third cut piece from the book to review a portion of a further subsequent page; and,
covering the book with a transparent or semi-transparent shell.

34. The method for creating an aesthetic work of art according to claim 33, wherein the first, second and third rectangular patterns are complete rectangles.

35. The method for creating an aesthetic work of art according to claim 33, wherein the first, second and third rectangular patterns are portions of rectangles having at least three sides.
